(19) United States
(12) Patent Application Publication
(10) Pub. No.: US 2011/0220665 A1
(43) Pub. Date: Sep. 15, 2011

(54) Drinking Game Cup or Attachment

(75) Inventors: Sean Michael McDonnell, Burlington, CT (US); Joseph Daniel Taylor, San Francisco, CA (US); Ethan Ross Rabinowitz, Westport, CT (US)

(73) Assignee: Sean McDonnell, Burlington, CT (US)

(21) Appl. No.: 13/045,739

(22) Filed: Mar. 11, 2011

Related U.S. Application Data
(60) Provisional application No. 61/313,190, filed on Mar. 12, 2010.

(51) Int. Cl. A47J 41/00; A47G 19/22; B65D 6/00

(52) U.S. Cl. 220/592.17; 220/703; 220/660; 220/600

(57) ABSTRACT

The present invention generally relates to drinking games and apparatuses for the use therewith. Specifically, this invention relates to an improved drinking game cup or attachment for the use with various drinking games. The drinking game cup or attachment may be designed in such a manner as to allow for simplified, accurate and reliable positioning of two or more drinking cups.

### CROSS REFERENCE TO RELATED APPLICATIONS

This application claims the benefit of U.S. Provisional Patent Application No. 61/313,190 Filed Mar. 12, 2010, the entire disclosure of which is incorporated herein by reference.

### FIELD OF THE INVENTION

The present invention generally relates to drinking games and apparatuses for the use therewith. Specifically, this invention relates to an improved drinking game cup or attachment for the use with various drinking games. The drinking game cup or attachment may be designed in such a manner as to allow for simplified, accurate and reliable positioning of two or more drinking cups.

### BACKGROUND OF THE INVENTION

In drinking games, for example “Beer Pong”, players are required to position or place cups in specific predetermined arrangements. Such arrangements are commonly referred to as “racks”. With existing cups, the consistency, precision, and overall quality of racks tends to vary widely between games and players. However, game rules typically require well aligned and snugly fit arrangements or racks. As with other sports, consistent court or playing field setup is very important for fair, reliable, and legitimate competition or game play to occur.

Therefore, there is a need in the art for an apparatus that simplifies the process of accurately and precisely positioning drinking game cups. These and other features and advantages of the present invention will be explained and will become obvious to one skilled in the art through the summary of the invention that follows.

### SUMMARY OF THE INVENTION

The present invention provides a drinking game cup or an attachment to an ordinary drinking game cup. The drinking game cup or attachment herein described allows for the accurate and precise positioning of drinking cups for the use in drinking games.

According to an embodiment of the present invention, a drinking game cup is provided, comprised of a holding space for the retention of a substance (e.g., potable liquids, potable gels), a rim portion with a substantially circular cross section located at the top of said holding space and a base portion with a substantially polygonal base located at the bottom of said holding space.

According to an embodiment of the present invention, a rim portion of the drinking game cup herein described is designed to allow for the filling and emptying of the holding space of the drinking game cup with substances. The rim portion may also be designed to allow for the receipt of objects into the holding space of the drinking game cup. For instance, the rim portion may be designed to receive ping pong balls, coins or other drinking game components during the game play of a drinking game.

According to an embodiment of the present invention, the base portion of the drinking game cup herein described is designed to allow for the rapid, accurate and precise positioning of the drinking game cup in relation to other drinking game cups of the type and design herein described.

According to an embodiment of the present invention, the holding space of the drinking game cup herein described is designed to receive various amounts of liquids (e.g., beer, liquor, water, soda), potable gels (e.g., alcohol infused gelatins, gelatin products), game components (e.g., quarters, ping pong balls) or any combination thereof.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is a perspective view of a drinking game cup in accordance with an embodiment of the present invention;

FIG. 2 is a perspective view of a drinking game cup in accordance with an embodiment of the present invention;

FIG. 3 is a perspective view of a drinking game cup in accordance with an embodiment of the present invention;

FIG. 4 is a side view of a drinking game cup in accordance with an embodiment of the present invention;

FIG. 5 is a side view of a drinking game cup in accordance with an embodiment of the present invention;

FIG. 6 is a top view of a drinking game cup in accordance with an embodiment of the present invention;

FIG. 7 is a cross sectional side view of a drinking game cup in accordance with an embodiment of the present invention;

FIG. 8A is a perspective view of one possible arrangement, or rack, using ten drinking game cups in accordance with an embodiment of the present invention;

FIG. 8B is a bottom view of one possible arrangement, or rack, using ten drinking game cups in accordance with an embodiment of the present invention;

FIG. 9A is a perspective view of one possible arrangement, or rack, using four drinking game cups in accordance with an embodiment of the present invention;

FIG. 9B is a top view of one possible arrangement, or rack, using four drinking game cups in accordance with an embodiment of the present invention;

FIG. 10 is a perspective view of one potential arrangement, or rack, using sixteen drinking game cups in accordance with an embodiment of the present invention;

FIG. 11A is a perspective view of an alternative embodiment of a drinking game cup attachment in accordance with the present invention;

FIG. 11B is a perspective view of an alternative embodiment of a drinking game cup attachment in accordance with the present invention;

FIG. 11C is a top view of an alternative embodiment of a drinking game cup attachment in accordance with the present invention;

FIG. 11D is a bottom view of an alternative embodiment of a drinking game cup attachment in accordance with the present invention;

FIG. 11E is a side view of an alternative embodiment of a drinking game cup attachment in accordance with the present invention;

FIG. 12A is a perspective view of an alternative embodiment of a drinking game cup in accordance with the present invention;

FIG. 12B is a perspective view of the internal component of an alternative embodiment of a drinking game cup in accordance with the present invention;

FIG. 12C is a perspective view of the cross section of an alternative embodiment of a drinking game cup in accordance with the present invention;

FIG. 12D is a perspective view of the external component of an alternative embodiment of a drinking game cup in accordance with the present invention;

FIG. 13A is a perspective view of an alternative embodiment of a drinking game cup in accordance with the present invention;

FIG. 13B is a perspective view of an alternative embodiment from a below angle of a drinking game cup in accordance with the present invention;

FIG. 13C is a perspective view of the cross section of an alternative embodiment of a drinking game cup in accordance with the present invention; and

FIG. 14 is an enlarged below-angle perspective view of an alternative embodiment of a drinking game cup in accordance with the present invention

### DETAILED SPECIFICATION

The present invention generally relates to drinking games and apparatuses for the use therewith. Specifically, this invention relates to an improved drinking game cup or attachment for the use with various drinking games. The drinking game cup or attachment may be designed in such a manner as to allow for simplified, accurate and reliable positioning of two or more drinking cups.

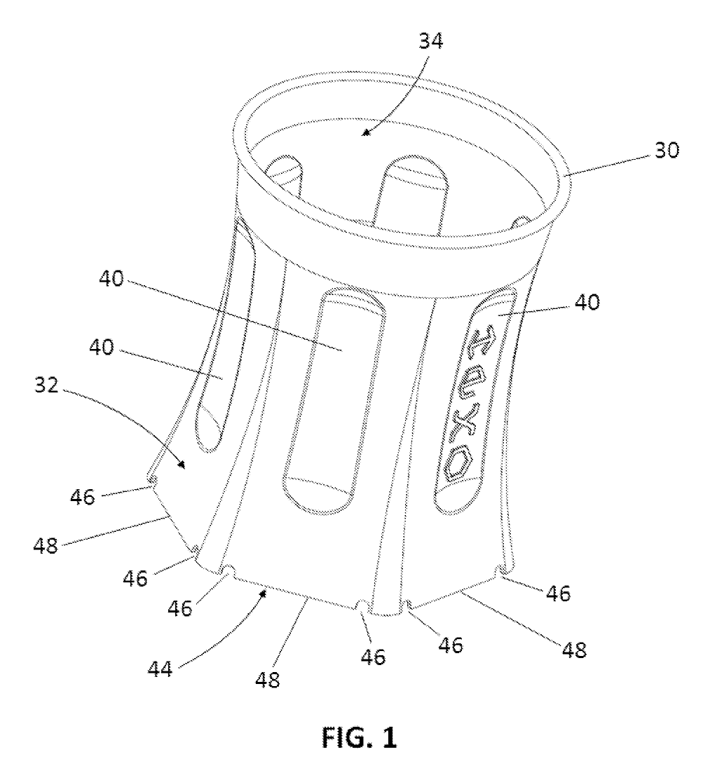

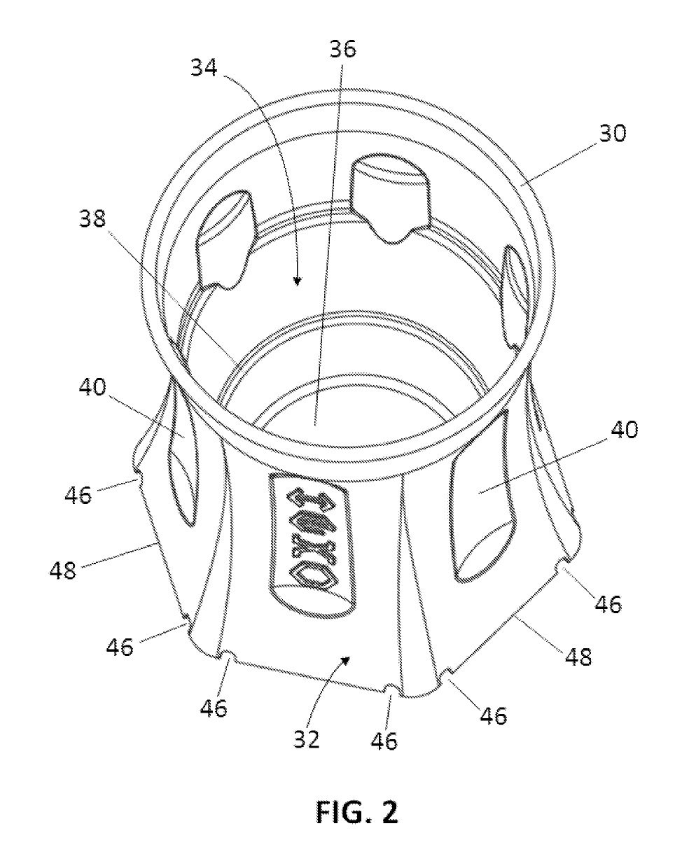

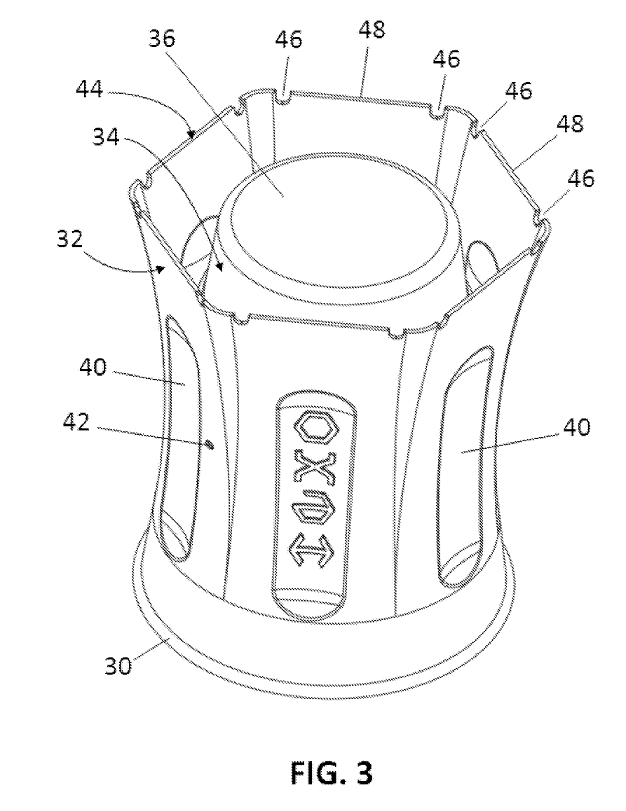

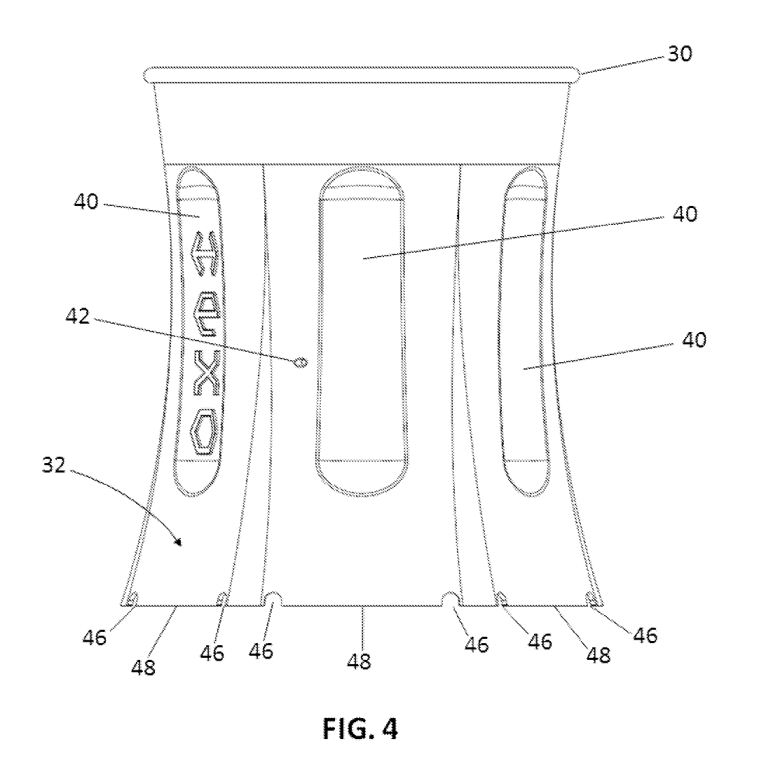

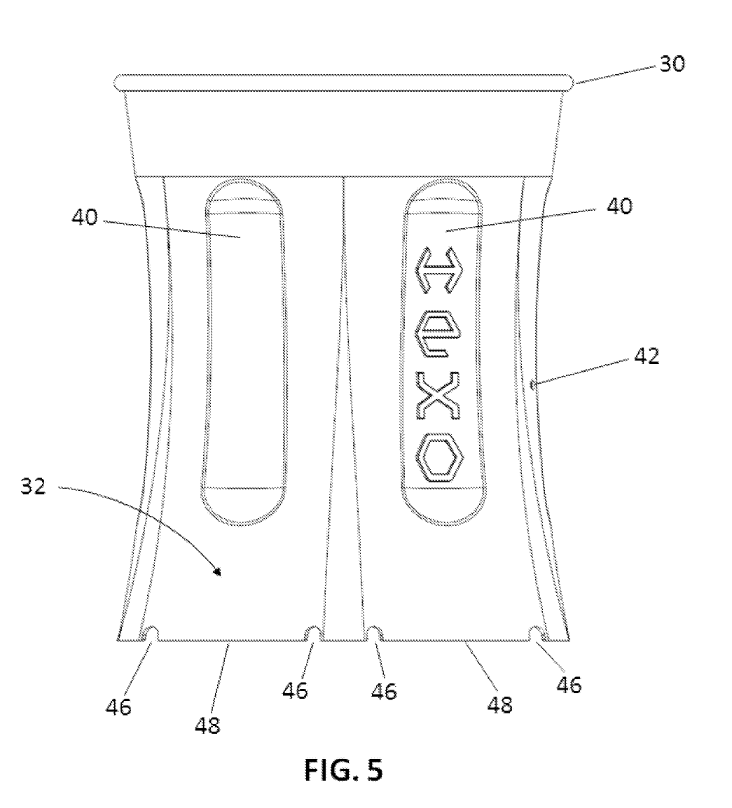

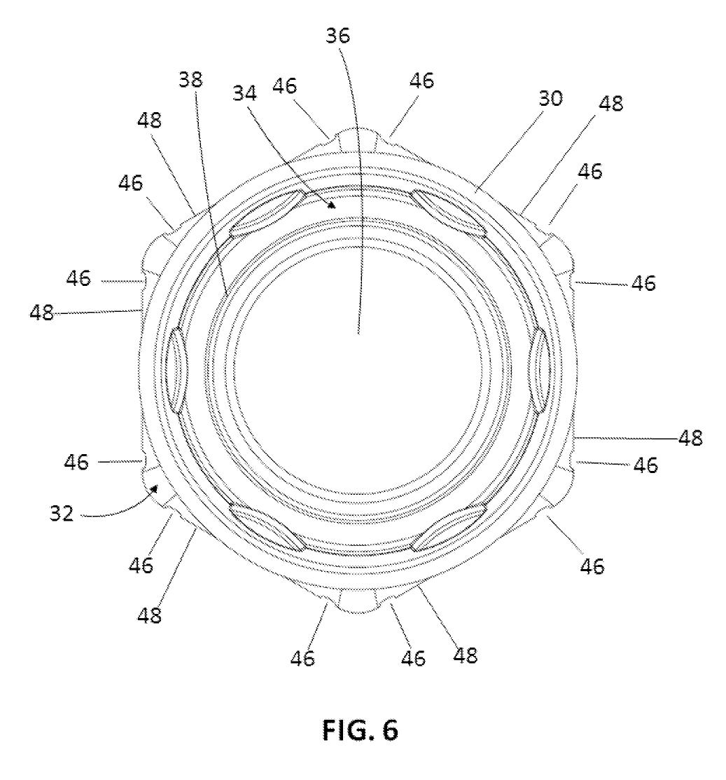

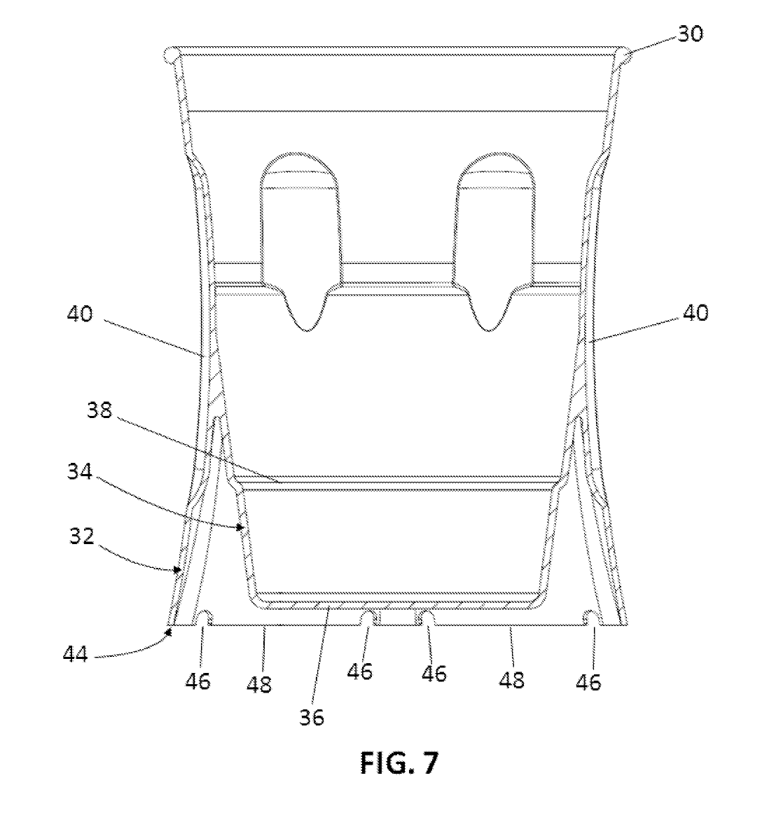

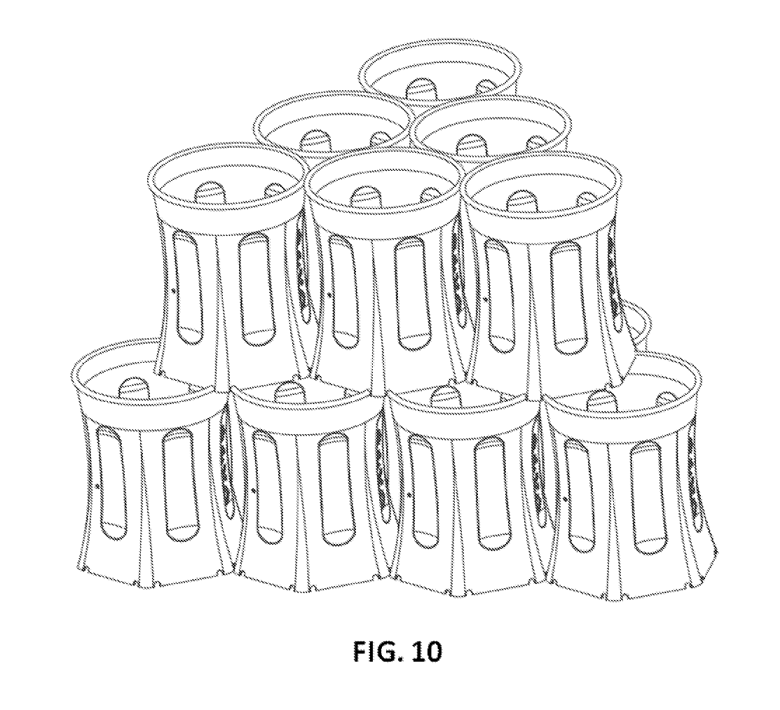

Turning now to FIGS. 1, 2, 3, 4, 5, 6, 7, 8A, 8B, 9A, 9B, and 10, a drinking game cup in accordance with an embodiment of the present invention is shown. At the top of this embodiment is a substantially circular ring or rim 30. The rim 30 of this embodiment has a uniform circular cross section (see FIG. 7). In other embodiments the rim 30, or the rim cross-section, may be a different size or shape. One of ordinary skill in the art would appreciate that rims of any size or shape may be utilized with embodiments of the present invention, and embodiments of the present invention are contemplated for use with rims of any size and shape.

At the bottom of this embodiment is a base 44. According to an embodiment of the present invention, the base 44 geometry is hexagonal, in other words, a polygon with six edges and six vertices. The width of the base 44 in this embodiment is equal to the outer diameter of the rim 30. In other embodiments, the base 44 could be a different shape or size such as square, diamond, or any other shape that can be tessellated or tiled, including any interlocking or interconnecting shapes or geometry. Each external edge of the base 44 will be referred to as an alignment edge 48. An alignment edge 48 is also formed by, connected to, or part of an external wall 32. The external wall 32 connects the base 44 to the rim 30. Because the external wall 32 connects or joins circular geometry with hexagonal geometry, it has a unique shape and curvature. In other embodiments this curvature may.

According to an embodiment of the present invention, merging with the inside surface of the external wall 32 is an internal wall 34. From the junction of the internal wall 34 with the external wall 32 upward towards the rim 30, the two walls essentially become one and the same. The internal wall is enclosed at the bottom by an internal floor 36. Together, the rim 30, external wall 32, internal wall 34, and internal floor 36 surround a holding space to hold contents.

According to an embodiment of the present invention, the internal wall 34 may have a bend, shoulder, line, or fill line 38. Fill line 38 may be located at a specific height above the internal floor 36. One of ordinary skill in the art would appreciate that the height of a fill line 38 may be set at numerous different heights, and embodiments of the present invention are contemplated for use with fill line 38 set to any height. In other embodiments there may be a number of additional fill lines 38, or there may be no fill line 38 at all. In other embodiments a fill line 38 may be built into the external wall 32. Each fill line 38 forms a visually observable line indicative of a predetermined volume within the holding space.

According to an embodiment of the present invention, built into the external wall 32 (and partially in the wall section where the external wall 32 has joined with the internal wall 34) is an ergonomic curve, groove, or grip indent 40. This embodiment has six grip indents 40. The grip indent 40 size, shape, or location on the external wall 32 may vary in other embodiments. In other embodiments there may be a number of additional grip indents 40, or there may be no grip indent 40 at all.

According to an embodiment of the present invention, in the external wall 32 there is an opening, cutout, slot, or drainage hole 42. The drainage hole 42 size, shape, or location on the external wall 32 may vary in other embodiments. In other embodiments there may be a number of additional drainage holes 42, or there may be no drainage hole 42 at all. In this embodiment, the geometry of the drainage hole 42 is such that it could be more easily formed by and removed from an injection molding tool.

According to an embodiment of the present invention, on the base 44 and external wall 32 there is a cutout, void, groove, or base notch 46. In this embodiment there are a total of twelve base notches 46. The shape and size of the base notch 46 may vary in other embodiments. One of ordinary skill in the art would appreciate that there are numerous shapes and sizes of base notches that would be appropriate for use with embodiments of the present invention, and embodiments of the present invention are contemplated for use with any shape or size of base notches. In other embodiments there may be a number of additional base notches 46, or there may be no base notch 46 at all.

Operation

In drinking games, for example Beer Pong, players are required to position or place cups in specific predetermined arrangements. Such arrangements are commonly referred to as “racks”. With existing cups, the consistency, precision, and overall quality of racks tends to vary widely between games and players. However, game rules typically require well aligned and snugly fit arrangements or racks. As with other sports, consistent court or playing field setup is very important for fair, reliable, and legitimate competition or game play to occur.

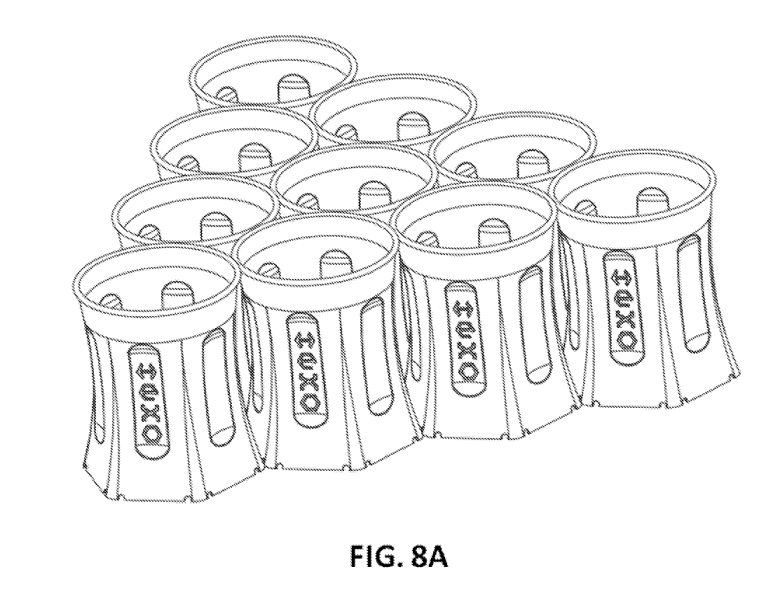

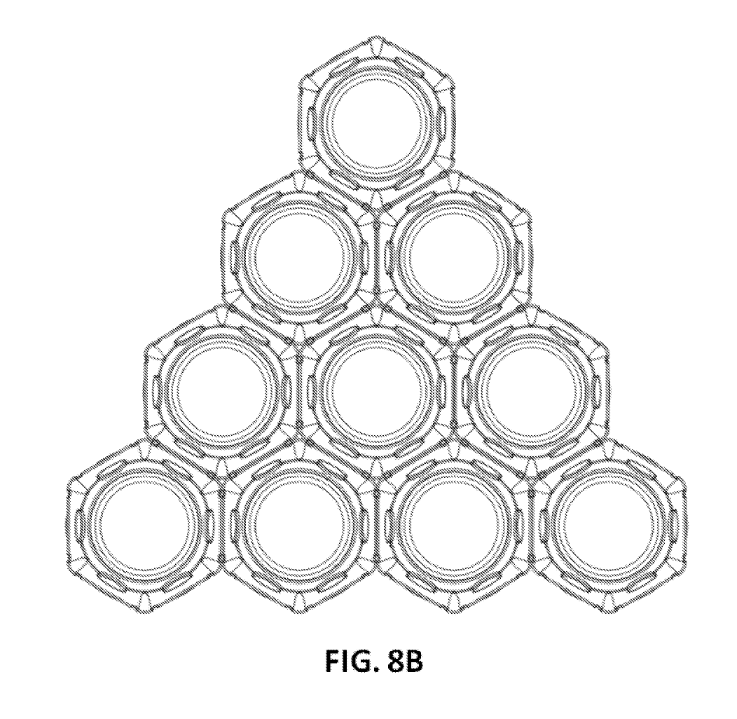

Users of drinking game cups in accordance with embodiments of the present invention can utilize the alignment edges 48 to achieve an improved alignment, rack, or fit with adjacent cups. With existing cups, the user will typically use the cup's rim as a guide. However, the rim of currently existing cups only provides users with a single, usually tangential, point of contact to assist alignment and spacing. Drinking game cups in accordance with embodiments of the present invention provide the user with multiple points of contact (i.e., the alignment edges 48), which can be used to assist the user in the racking or arrangement process. By increasing the number of contact points, the drinking game cup has less free range of motion, and the user can achieve higher quality cup arrangements, do so more easily, and do so in less time. This embodiment also allows users to more easily align racks or cup arrangements with lines on the playing surface or other guides which may be in place during game play. See FIG. 8a and FIG. 8b for an example of a high quality rack achieved using ten drinking game cups in accordance with an embodiment of the present invention.

According to an embodiment of the present invention, the geometry of the base 44 allows the user to vertically stack multiple units of this embodiment upon or above one another. Existing cups typically have a base diameter or width that is smaller than the rim diameter or width. Therefore, when placed above one another the cups tend to nest or fall into the cup below. Drinking game cups, in accordance with embodiments of the present invention, avoid this problem, allowing the user to place or stack cups above one another. This allows users to form new vertical or three dimensional racks or cup arrangements.

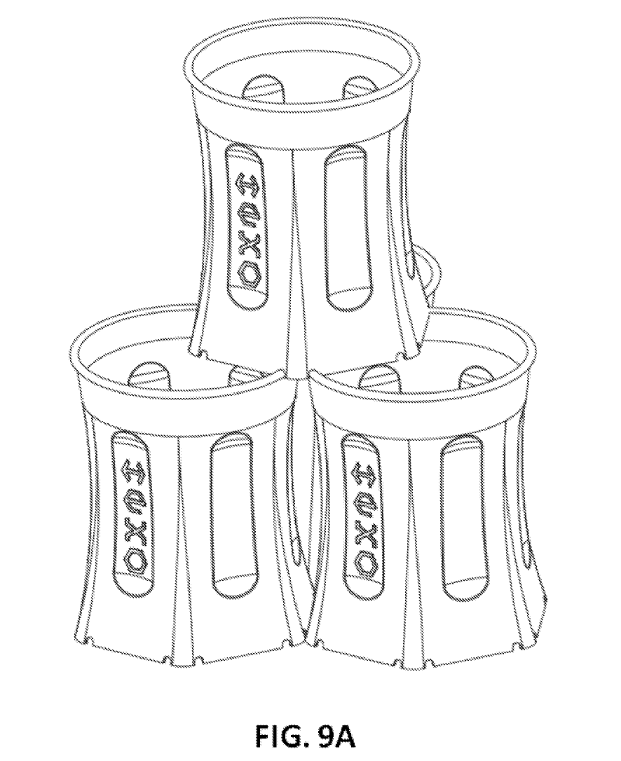

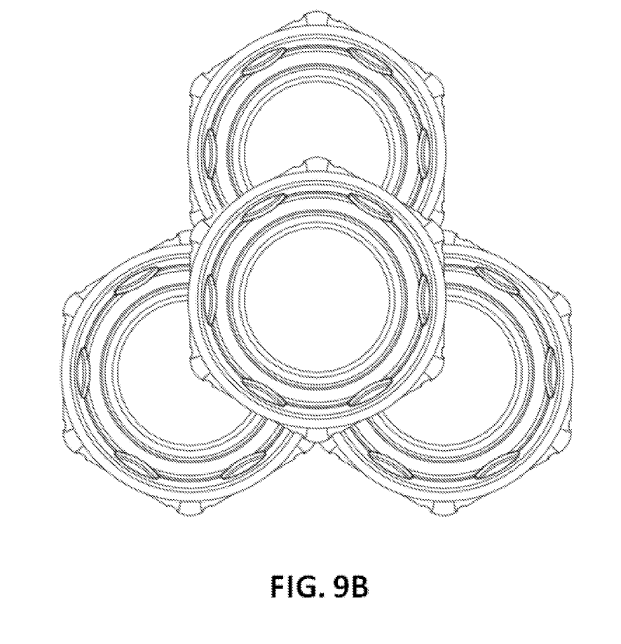

According to an embodiment of the present invention, the base notches 46 of this embodiment allow users to vertically stack cups more securely upon each other. The base notches 46 also allow the user to achieve new and unique cup arrangements, or racks. The base notches 46 also reduce the likelihood of this embodiment sliding, falling, or otherwise moving from the desired rack position during game play. The base notches 46 also allow the user to vertically stack one drinking game cup or attachment on top of three individual drinking game cups or attachments (see FIG. 9A and FIG. 9B). The base notches 46 also improve the overall quality of the rack both laterally and vertically.

According to an embodiment of the present invention, the bottom surface of the internal floor 36 is raised slightly above the plane of the base 44 to prevent interference during vertical stacking. This allows the base notch 46 to seat or fit better on the rim 30 or multiple rims below it (see FIG. 7).

According to an embodiment of the present invention, the grip indent 40 improves the ergonomics of this embodiment, making it Is easier for users to move around, pick up, hold on to, and put down.

The rim 30 provides an opening for liquids or other objects to enter this embodiment's internal holding space. The exposed portion of the rim 30 follows a smooth and continuous substantially circular curvature and has a substantially uniform circular cross section; this provides improved consistency, reliability, and predictability for users during game play. This is particularly important for drinking games such as Beer Pong where the impact and resulting reaction of balls (typically ping pong balls) off of the rim 30 is critical to the outcome of the game.

According to an embodiment of the present invention, the drainage hole 42 allows fluid that might otherwise be trapped in the void between the external wall 32 and the internal wall 34 to leak, flush, or drain out of said void. For example, if a drinking game cup, in accordance with an embodiment of the present invention, is placed top end down in a dish washing machine for cleaning, the drainage hole 42 will reduce the amount of trapped fluids remaining at the end of the dish washing cycle. This will make it easier for users to remove drinking game cups, in accordance with embodiments of the present invention, from a dishwasher.

According to an embodiment of the present invention, the fill line 38 makes it easier for users to more consistently fill this embodiment with a predetermined amount of liquid. The fill line 38 forms a visually observable line indicative of a specific predetermined volume within the holding space. In a drinking game such as Beer Pong, players typically want to evenly distribute 24 fluid ounces of beer, 2 beer cans, throughout 10 separate cups (2.4 fluid ounces in each cup). The fill line 38 in this drinking game cup, in accordance with an embodiment of the present invention, is located at a position which assists or guides the user in filling the holding space to 2.4 fluid ounces.

According to an embodiment of the present invention, the geometry of the internal wall 34 and external wall 32 is such that this embodiment may be more easily mass produced using injection molding techniques. The shape and size of the internal wall 34 and external wall 32 may vary in other embodiments. One of ordinary skill in the art would appreciate that various shapes and sizes of internal wall 34 and external wall 32 may be used with embodiments of the present invention, and embodiments of the present invention are contemplated for use with internal walls and external walls of any shape or size. Furthermore, the internal wall 34 geometry of this embodiment is such that some traditional elements of game play may be maintained.

### Additional Embodiment

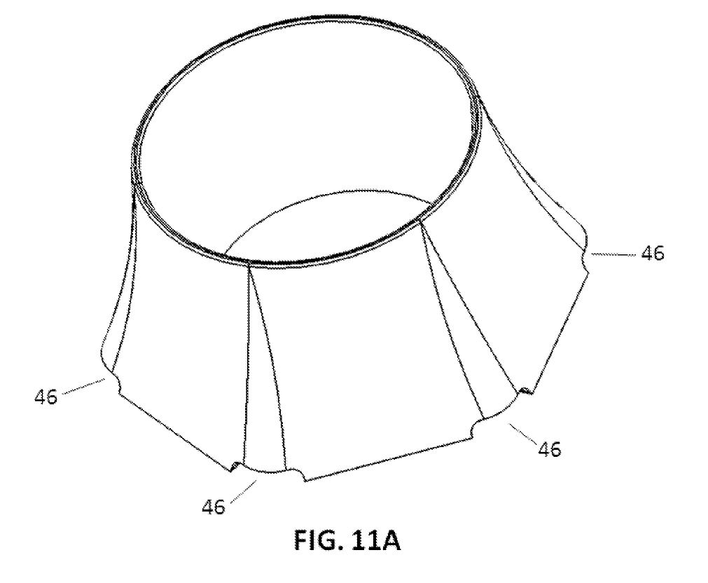

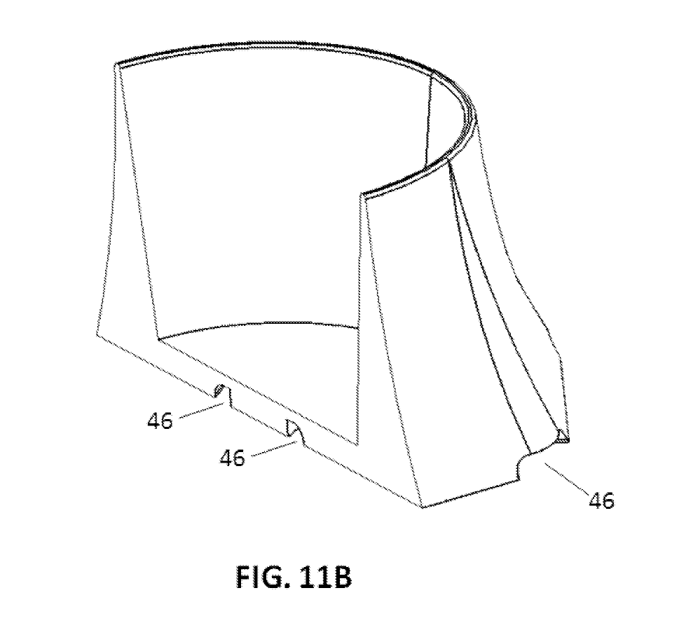

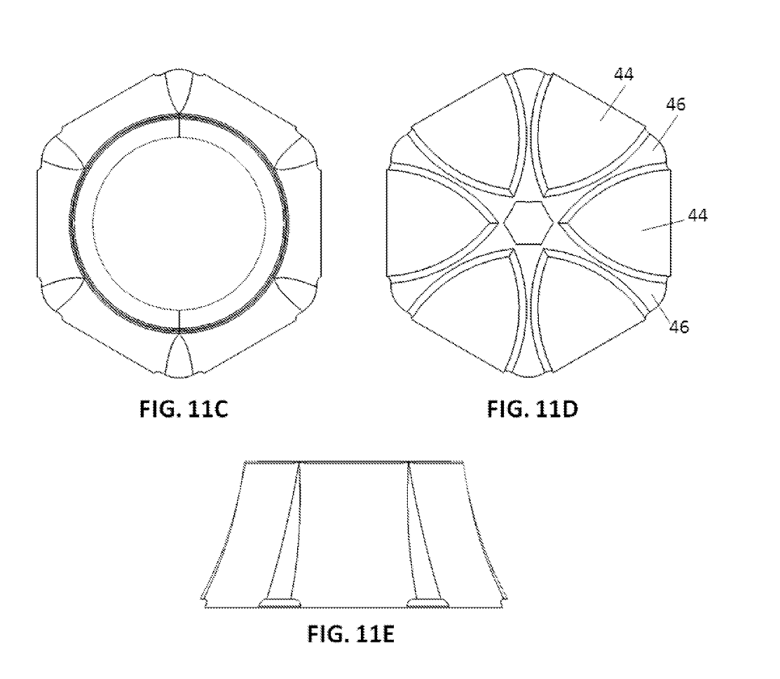

### FIGS. 11A-11E

Turning now to FIGS. 11A, 11B, 11C, 11D, and 11E, an alternate embodiment of the present invention is shown.

According to this alternate embodiment, a drinking game cup attachment is provided. The drinking game cup attachment is intended to be used in conjunction or combination with existing or traditional cups. A cup can be inserted into the holding space of this drinking game cup attachment. The geometry of the holding space may vary in other embodiments to accommodate insertion of, or attachment to, various other sizes and types of cups or game play devices. One of ordinary skill in the art would appreciate that the holding space may be of various sizes and types in order to receive various types of cups or game play devices, and embodiments of the present invention are contemplated for use with holding spaces of any size or shape.

Turning now specifically to FIG. 11D, a drinking game cup attachment, in accordance with an embodiment of the present invention is shown. FIG. 11D provides one example of how the base 44 and base notch 46 geometry may vary.

According to an embodiment of the present invention, the drinking game cup attachment may be made of, but not limited to, rubber foam, open cell foam, or neoprene. One of ordinary skill in the art would appreciate that numerous drinking game cups and drinking game cup attachments could be made of numerous materials, and embodiments of the present invention are contemplated for use with any material suitable for making drinking game cups and drinking game cup attachments.

According to an embodiment of the present invention, drinking game cups and drinking game cup attachments may be made of an insulating material. In these embodiments, the drinking game cup or drinking game cup attachment will keep the contents of the user's cup cooler for an extended period of time.

According to an embodiment of the present invention, drinking game cup attachments will also improve the inserted or attached cup's grip or traction with the game play surface and/or cups below. In this manner, fewer interruptions to the game will occur for the purpose of realigning the cups that may have been inadvertently moved during game play.

According to an embodiment of the present invention, drinking game cup attachments may also be easier to transport and may consume less space during transportation or storage.

### Additional Embodiment

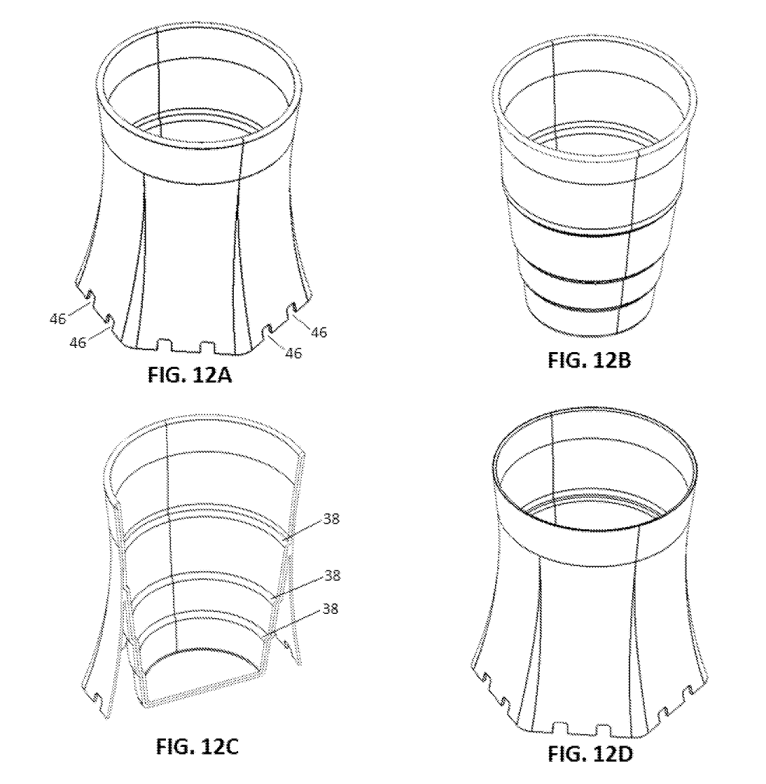

### FIGS. 12A-12D

Turning now to FIGS. 12A, 12B, 12C, and 12D, an alternate exemplary embodiment of the present invention is shown. This exemplary embodiment consists of an inner component (FIG. 12B) and an outer component (FIG. 12D) which can be combined via ultrasonic welding, “over molding” or “double shot” if using injection molding techniques, or otherwise joined together to form a single unit. This exemplary embodiment may be more efficient to manufacture. In addition, using inner and outer components may provide additional means of adding color to this embodiment during manufacturing.

Turning now to FIG. 12C, an embodiment of the present invention is provided as an example of how additional fill lines 38 may be incorporated. This exemplary embodiment also provides an example of different base notch 46 geometry.

### Additional Embodiment

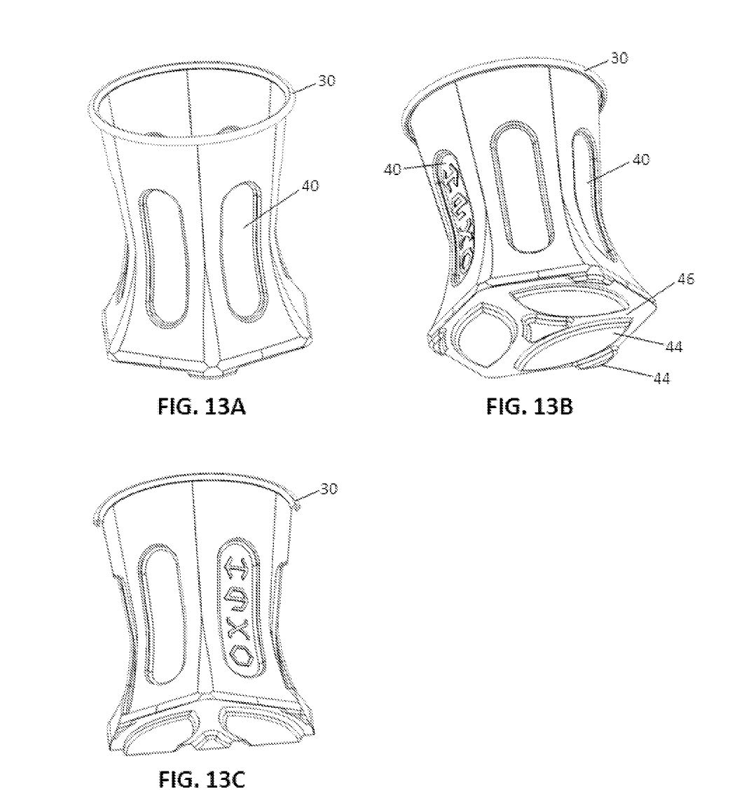

### FIGS. 13A-13C

Turning now to FIGS. 13A, 13B, and 13C, another exemplary embodiment of a drinking game cup, in accordance with an embodiment of the present invention is illustrated.

The exemplary embodiment shown in FIGS. 13A-13C also provide an example of an alternative rim 30, grip indent 40, and base notch 46 geometry.

### Additional Embodiment

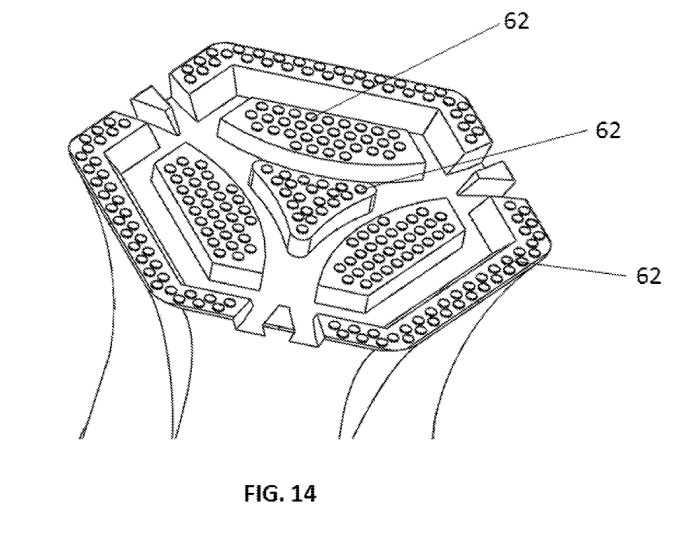

### FIG. 14

Turning now to FIG. 14, another exemplary embodiment of the Drinking Game Cup or Attachment is illustrated. This exemplary embodiment has a number of feet or fraction nubs 62. The fraction nubs 62 in this exemplary embodiment are geometric protrusions. The shape, size, location, and number of traction nubs 62 may vary in other embodiments. Alternatively, a surface texture may be applied to the manufacturing tool to achieve very small traction nubs 62. Additionally, traction nubs 62 may be over molded, joined using adhesive materials, ultrasonically welded, or otherwise attached to the base of other embodiments. The traction nubs 62 serve to improve the embodiment's grip or traction on whichever surface it is placed; thereby reducing the amount of movement the embodiment will experience when forces are applied to it. An increase in traction arises from an increase in friction depending on the material used, many materials could be used. Alternatively, the traction nub geometry may reduce motion as a result of the drag force exerted in a direction opposite of motion from any liquid on the game play surface (some game play surfaces are wet or may become wet).

Advantages

The Drinking Game Cup or Attachment comprising any feature described, either individually or in combination with any feature in any embodiment, may have one or more of the following advantages:
Improves the consistency of game play;
Improves the quality of game play;
Improves the quality of drinking game cup arrangements, also known as “racks”;
Improves the consistency of drinking game cup arrangements, also known as “racks”;
Reduces the amount of time required to rack;
Easier to use;
Improves the precision of rack arrangements and alignments;
Improves the orientation of rack arrangements and alignments;
Improves the stability of rack arrangements;
Allows drinking game players to form racks, or cup arrangements, which were previously difficult or impossible to form;
Allows vertical stacking of a drinking game cup on the rim of a cup below;
Allows vertical stacking of a drinking game cup on the rims of multiple cups below it;
Reduces the likelihood of undesired movement during game play;
Easier to clean using a dishwasher;
Easier to place in and remove from a dishwasher;
Easier for users to pick up, hold, and put down;
Easier to fill to a desirable or predetermined level;
Increases the amount of time the contents of a user's cup may remain at a desired temperature;
Easier to aim at; and
Easier to manufacture or mass produce.

### Conclusion, Ramifications, and Scope

While my above description contains many specificities, these should not be construed as limitations on the scope, but rather as an exemplification of one [or several] preferred embodiment thereof. Many other variations are possible.

For example, the alignment edges 48 could be vertically enlarged to become planar surfaces. The alignment edges 48 could be formed by geometry at the top, middle, or any other location on an alternative embodiment. In other embodiments, the alignment edges 48 could be formed by a different shape such as a square, diamond, or any other shape that can be tessellated or tiled, including any interlocking or interconnecting shapes or geometry.

Additionally, a number of material coloration techniques or approaches could be employed to improve the visual contrast between individual embodiments and between the internal and external walls of one [or several] embodiments. This would make the embodiment easier to aim at.

Furthermore, adhesive materials or magnets could be used to increase the strength or amount of contact between the alignment edges 48 of separate embodiments in racks.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A drinking game cup, the drinking game cup comprising:
a holding space,
wherein said holding space is formed by an external wall, internal wall and an internal floor,
wherein said external wall, internal wall and internal floor are joined in such a manner as to allow for the retention of substances within the holding space;
a rim attached to a top opening of said holding space,
wherein said rim is substantially circular,
wherein said rim allows for the transfer of substances to and from said holding space; and
a base attached to a bottom end of said holding space,
wherein said base is substantially polygonal,
wherein said base is comprised of a plurality of alignment edges.

2. The system of claim 1, wherein said external wall of said holding space is further comprised of a drainage hole.

3. The system of claim 1, wherein said base is further comprised of a plurality of traction nubs.

4. The system of claim 1, wherein said external wall of said holding space is further comprised of a grip indent.

5. The system of claim 1, wherein said internal wall of said holding space is further comprised of one or more fill lines.

6. The system of claim 5, wherein said one or more fill lines are located at specific heights for measuring specific amounts of substances contained in said holding space.

7. The system of claim 1, wherein said drinking game cup is constructed of an insulating material.

8. The system of claim 1, wherein said base is further comprised of one or more base notches.

9. A drinking game cup attachment, said drinking game cup attachment comprising:
a substantially polygonal base,
wherein said substantially polygonal base is comprised of an external wall, an internal wall, and a plurality of alignment edges,
wherein said internal wall is capable of receiving a cup.

10. The system of claim 9, wherein said base is further comprised of a plurality of fraction nubs

11. The system of claim 9, wherein said drinking game cup attachment is constructed of an insulating material.

12. The system of claim 9, wherein said base is further comprised of one or more base notches.
